(19) United States
(12) Patent Application Publication
(10) Pub. No.: US 2012/0035977 A1
(43) Pub. Date: Feb. 9, 2012

(54) Enterprise Consumer Complaints Program

(75) Inventors: Angela W. Wells, Tampa, FL (US); Judyellen A. Gauthier, Charlotte, NC (US); Thomas J. Healy, Concord, NC (US)

(73) Assignee: BANK OF AMERICA CORPORATION, Charlotte, NC (US)

(21) Appl. No.: 12/849,050

(22) Filed: Aug. 3, 2010

(51) Int. Cl. G06Q 10/00

(52) U.S. Cl. 705/7.29

(57) ABSTRACT

A method and system are provided for identifying, tracking and reporting customer complaints across multiple lines of business of an organization. Each line of business of the organization utilizes a system of record configured to identify an issue received from a customer as a “complaint” based on the same set of criteria and then collect data associated with the complaint. A centralized complaint portal of the organization extracts complaint data from each of the systems of record, processes the data to identify one or more lines of business and/or individuals responsible for or capable of handling the complaints, and routes the complaint data to the identified lines of business and/or individuals for resolution. The complaint portal also analyzes the extracted data to identify trends in the complaints, specific complaint escalations, stages of resolution for complaints, and other similar types of issues related to the complaints, and generates one or more summary reports based on the analyzed data.

### FIELD

Aspects of the disclosure relate to customer complaint handling. More specifically, aspects of the disclosure relate to identifying, tracking and reporting customer complaints across multiple lines of business of an organization.

### BACKGROUND

Many large, complex, multinational organizations, such as financial institutions, face careful scrutiny to ensure that they are being managed in a way that properly services the needs of consumers while also complying with various government rules and regulations. A variety of factors are considered in assessing whether a large organization has adequate control over its operations, including the organization's ability to efficiently and effectively handle customer complaints.

Some of the difficulties associated with managing customer complaints in a large organization result from a lack of communication between different lines of business and inconsistent processes for complaint handling and resolution. For example, an associate responsible for complaints related to one line of business of an organization may determine that a particular issue is actually a complaint that involves an entirely different line of business, and therefore the associate is not the appropriate party to handle the complaint. In such a situation, the associate may be forced to reach out to other lines of business for assistance in addressing and researching the complaint, which can result in unnecessary delay and duplicative effort in resolving the complaint.

### BRIEF SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

One or more aspects described herein relate to providing a method and system for identifying, tracking and reporting customer complaints across multiple lines of business (e.g., business units, product divisions, service departments, etc.) of an organization. The method and system described herein enables members (e.g., employees, associates, advisors, representatives, etc.) of each line of business who are responsible for handling customer complaints to distinguish complaints from other types of issues requiring attention and resolution.

According to one or more other aspects described herein, each line of business of the organization utilizes a system (server, database, computer, etc.) of record configured to identify an issue as a “complaint” based on the same set of criteria and then collect data associated with the complaint. For example, an issue received from a customer may be identified as a “complaint” if the issue was not resolved by the initial point of contact of the customer (e.g., first-level associate of a business unit) and any of three criteria established by the organization is applicable to the issue received. Once a complaint is identified, the system of record for the line of business in which the complaint was received collects and maintains data associated with the complaint, including customer identification information, complaint information, complaint updates and the like.

One or more other aspects described herein relate to a centralized complaint portal (e.g., computer, server, engine, etc.) of the organization extracting complaint data from each of the systems of record, processing the data to identify one or more lines of business and/or individuals responsible for or capable of handling the complaints, and routing the complaint data to the identified lines of business and/or individuals for resolution.

One or more other aspects described herein relate to the complaint portal analyzing the extracted data to identify trends in the complaints, specific complaint escalations, stages of resolution for complaints, and other similar types of issues related to the complaints, and then generating one or more summary reports based on the analyzed data. The reports generated by the complaint portal are then made available to various lines of business and/or members of the organization.

Aspects of the disclosure may be provided in a computer-readable medium having computer-executable instructions to perform one or more of the process steps described herein.

This summary is provided to introduce a selection of aspects of the disclosure in a simplified form that are further described below in the Detailed Description and accompanying figures. The summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is a schematic diagram showing example communication paths for collecting, extracting and reporting complaint data according to one or more aspects described herein;

FIG. 4 is a flowchart illustrating an example method of identifying and tracking a complaint according to one or more aspects described herein; and

FIG. 5 illustrates an example menu of complaint data that may be extracted by a complaint portal according to one or more aspects described herein.

### DETAILED DESCRIPTION

In the following description of various illustrative embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

By way of general introduction, one or more aspects described herein relate to providing an organization with a method and system for identifying, tracking and reporting customer complaints across multiple lines of business (e.g., business units, product divisions, service departments, etc.) of the organization. Each line of business of the organization utilizes a system (e.g., server, database, computer, etc.) of record for maintaining data associated with complaints received at or related to the line of business. In at least one arrangement, each system of record is configured to identify issues received at the line of business from customers as complaints if certain criteria are met. The set of criteria is applied by each system of record such that complaints are identified in a uniform manner across the various lines of business of the organization. Once an issue is identified as a complaint by a system of record, data associated with the identified complaint is collected by and maintained in the system of record.

As will be described in further detail below, such complaint data may include, for example, customer identification information about the customer from which the complaint was received, information about the type of complaint, the history of the complaint, the associate (e.g., member, employee, agent, etc.) who was the initial point of contact for the customer from whom the complaint was received, and the like. Additionally, as new data associated with identified complaints is received at a line of business, the system of record for that line of business updates the data maintained therein for the complaints with the new data received.

Other aspects described herein relate to a centralized complaint portal (e.g., computer, server, engine, etc.) of the organization extracting relevant data associated with identified complaints from the systems of record, processing the data to identify one or more lines of business and/or individuals responsible for or capable of handling the complaints, and routing the complaint data to the identified lines of business and/or individuals. In some arrangements the complaint portal may, in addition to or instead of routing the complaint data to the relevant lines of business and/or individuals, generate notifications for the lines of business and/or individuals indicating that the complaint data is available to reported or routed from the complaint portal.

Aspects described herein also relate to the complaint portal analyzing the extracted data to identify one or more trends in the complaints received from customers of the organization, track complaints that have been escalated for additional review, determine stages of resolution for various complaints, as well as numerous other functions related to such analysis. In at least some arrangements, the complaint portal utilizes the analyzed data to create one or more summary reports that are made available to various lines of business and/or members of the organization.

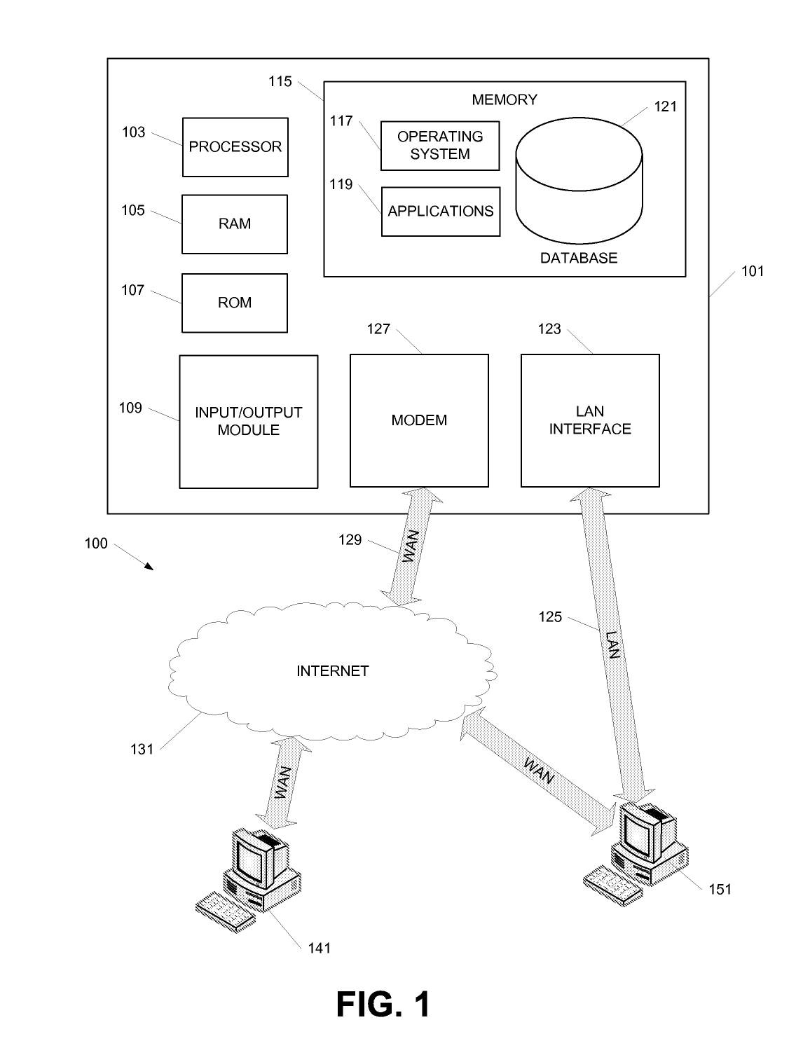

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with members of the organization, allowing interoperability between different lines of business of the organization that may reside at different physical locations.

Server 101 may operate in a networked environment 100 supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. Furthermore, any of a number of different communication protocols, such as TCP/IP, Ethernet, FTP, HTTP and the like, may be used within networked environment 100.

Additionally, an application program 119 used by the server 101 according to an illustrative embodiment of the disclosure may include computer executable instructions for invoking functionality related to providing access authorization for facilities and networks.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

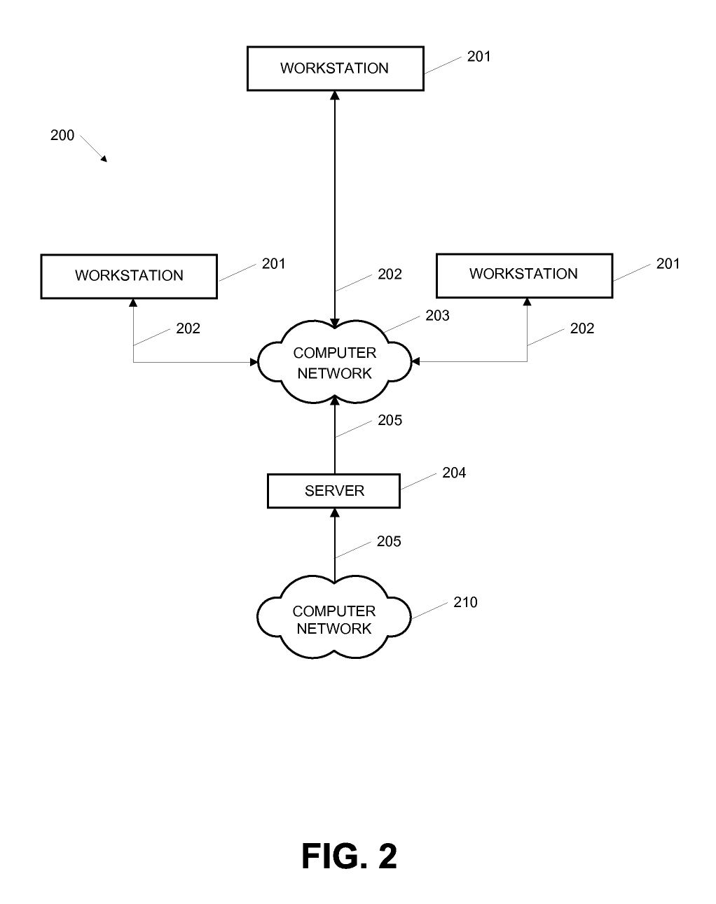

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same. Server 204 may be used to process the instructions received from, and the request submitted by, one or more members of the organization.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

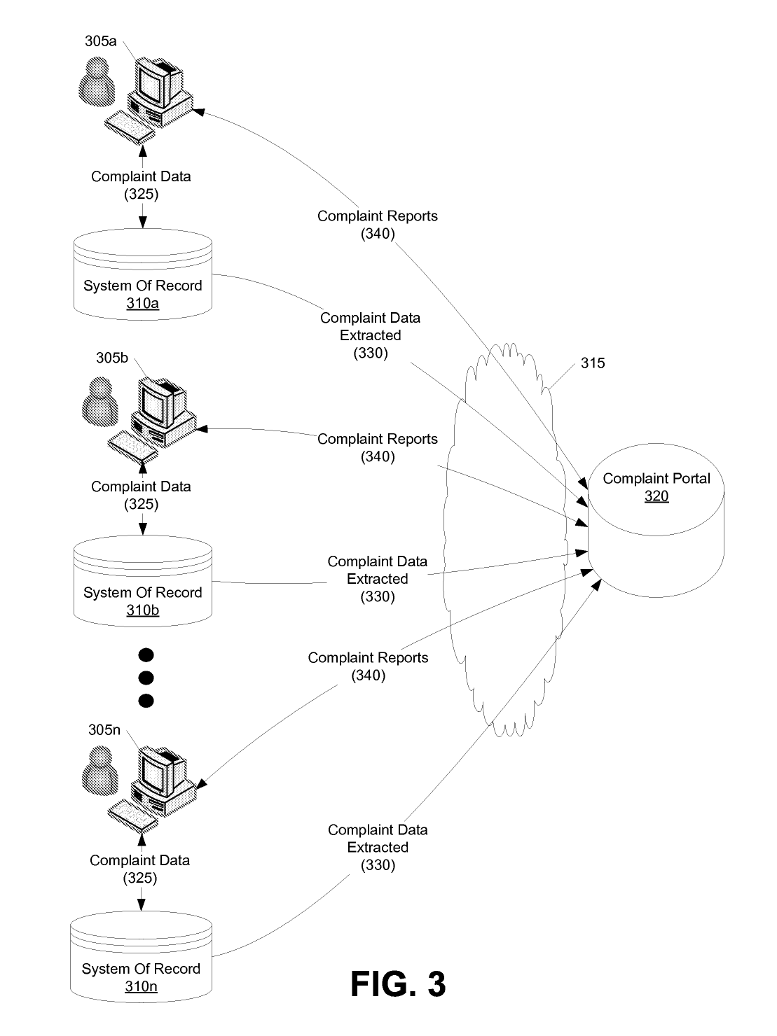

FIG. 3 illustrates an example network environment in which complaint data may be extracted from systems (e.g., servers, databases, computers, etc.) of record of various lines of business (e.g., business units, product divisions, service departments, etc.) of the organization by a complaint portal and complaints, reports, and other products of analysis sent back to the systems of record by the portal. As shown in FIG. 3, complaint portal 320, which in one or more arrangements is a computer (e.g., server, processor, engine, etc.) associated with the organization, communicates with systems of record 310a through 310n (where “n” is an arbitrary number) over network 315. In at lest some arrangements, systems of record 310a through 310n are each associated with and utilized by a different line of business of the organization for processing and maintaining data associated with complaints received at the line of business. For example, with regard to a financial institution, system of record 310a may be the system utilized by the credit card products line of business, while system of record 310b may be associated with the mortgage and home equity products line of business.

Complaint portal 320 also communicates over network 315 with associates 305a through 305n (where “n” is again an arbitrary number), where each of associates 305a through 305n is a member (e.g., agent, employee, representative, etc.) of a different line of business of the organization. As shown, each of associates 305a through 305n may have bidirectional communication with a corresponding system of record 310a through 310n such that complaint data 325 may be passed back and forth. Network 315 may be, for example, the Internet, a virtual private network (VPN), or other similar network capable of carrying electronic communications between complaint portal 320 and systems of record 310a through 310n and associates 305a through 305n. Similar to complaint portal 320, in some arrangements, systems of record 310a through 310n and associates 305a through 305n may include computers or other such processing devices capable of transmitting and receiving electronic communications over network 315.

As will be described in greater detail below, associates 305a through 305n may be the initial point of contact for receiving issues from customers of the organization. Upon receiving issues from customers, associates 305a through 305n may enter relevant data about the issues into systems of record 310a through 310n which, in some arrangements, may be configured to identify the issues received as complaints based on certain criteria. In such arrangements, the set of criteria is applied by each system of record 310a through 310n such that complaints are identified from issues in a uniform manner across the relevant lines of business of the organization. Once an issue received at a line of business, e.g., by an associate 305a of the line of business, is identified as a complaint by the system of record 310a of the line of business, complaint data 325 associated with the identified complaint may be collected by and maintained in the system of record 310a.

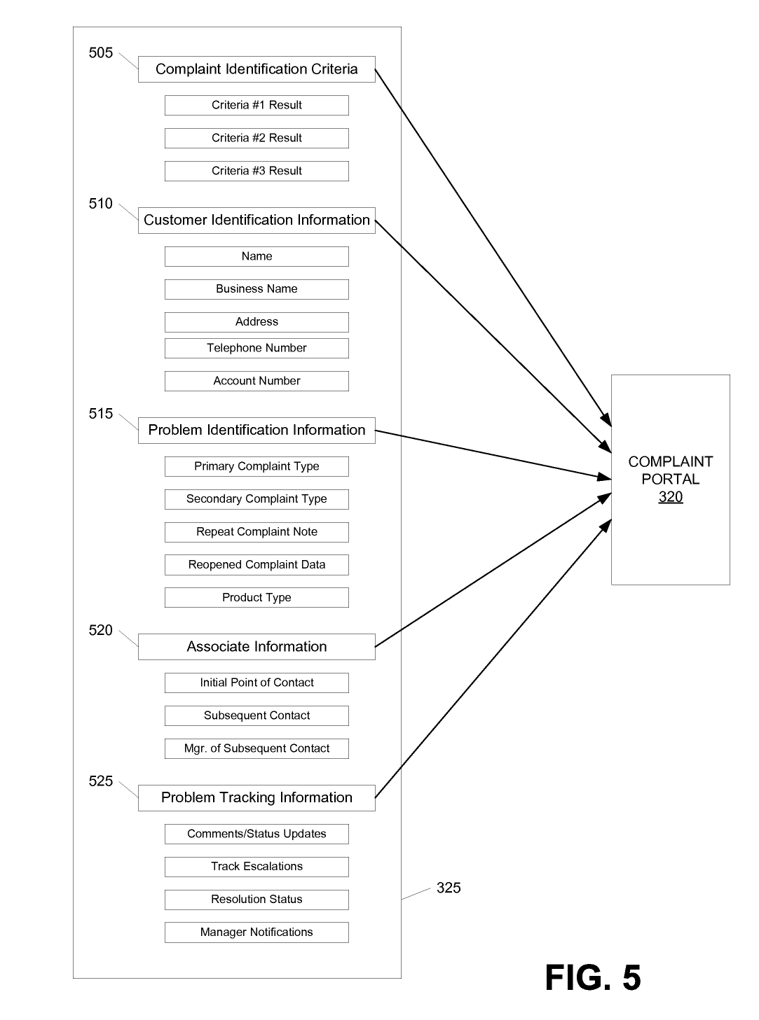

Referring to FIG. 5, illustrated are various types of complaint data 325 that may be collected by and maintained in the systems of record (e.g., 310a through 310n of FIG. 3) of the different lines of business of the organization, and also extracted from such systems of record into complaint portal 320. As shown in FIG. 5, complaint data 325 may include complaint identification criteria data 505, customer identification information 510, problem identification information 515, associate information 520 and problem tracking information 525. Each of the broad categories of complaint data 325 shown in FIG. 5 (e.g., customer identification information 510) may include subcategories of data, such as the customer's name, address, business name, etc., and may also include additional subsets of such smaller categories (not shown). It should be understood that the different categories and subcategories of complaint data shown in FIG. 5 are only illustrative examples of the types of data that may constitute complaint data, and various other types of data may additionally or alternatively be collected and maintained in the systems of record of the organization and/or extracted by complaint portal 320. For example, in some arrangements, the systems of record (e.g., 310a through 310n of FIG. 3) of the various lines of business may collect and maintain certain types of complaint data 325, while the complaint data made available to complaint portal 320 for extraction (e.g., complaint data extracted 330) may include a portion of the maintained complaint data 325.

Referring back to FIG. 3, complaint portal 320 may extract complaint data 330 from systems of record 310a through 310n and also transmit or otherwise make available to associates 305a through 305n, or their corresponding lines of business, complaint reports 340. In some arrangements, complaint portal 320 may analyze, format or otherwise process extracted complaint data to generate one or more complaint reports 340. Complaint reports 340 may identify trends in the complaints received from customers of the organization, may include tracking information about complaints that have escalated from different levels of review within the organization, and may also provide information about stages of resolution for certain existing or ongoing complaints. Complaint reports 340 may also include various other types of summary reporting information and analysis data in addition to or instead of the examples described above. In one or more arrangements, complaint reports 340 may include notifications for the lines of business and/or individuals of the organization who are responsible for or capable of handling certain complaints. Such notifications may include data indicating that extracted complaint data is available to be reported or routed from the complaint portal.

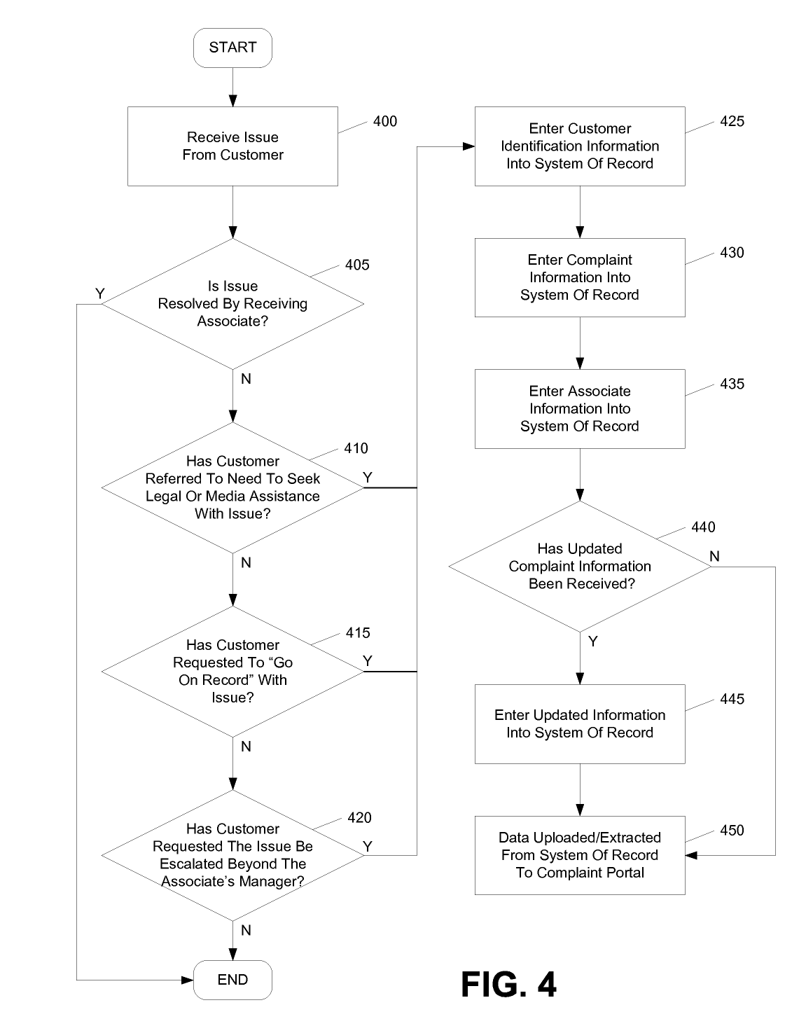

FIG. 4 illustrates an example process for identifying and tracking a complaint received by the organization according to one or more arrangements described herein. In step 400, a member of the organization (e.g., one of associates 305a through 305n shown in FIG. 3) receives an issue from a customer of the organization. As will be described in greater detail below, although an organization may receive many issues from customers, not all issues received are considered to be “complaints,” which are identified based on a set of criteria established by the organization and implemented in the same manner across various lines of business. For example, in step 400, a associate of a business unit may receive a call from a customer inquiring about certain account information or requesting to be put in contact with a particular member or department of the organization. While either of these examples may be categorized as an “issue” received from a customer, in at least some arrangements such issues are not considered to be “complaints.”

In step 405, the associate who received the issue from the customer, or another member of the organization, such as a supervisor who monitors all incoming calls to the business unit, determines whether the issue received was resolved. If so, then the process ends. However, if it is determined that the issue received was not resolved in the first instance in step 405, then the process continues to step 410 where the issue is assessed against the first of the set of criteria defining a complaint for the organization. In certain other arrangements, if it is determined in step 405 that the received issue was not resolved by the receiving associate, then the issue may be passed to a second associate or other reviewing individual, either of whom may or may not be associated with the same business unit as the receiving associate, before the process goes to step 410 to be assessed as a potential complaint.

Steps 410, 415 and 420 of the process shown in FIG. 4 include example criteria for identifying an issue received from a customer as a complaint to be handled by the method and system described herein. In at least one arrangement, steps 410, 415 and 420 may be referred to as “triggering questions,” since a positive response to any one of them results in the issue being identified as a complaint and the process continuing to step 425 where complaint data begins to be collected. It is to be appreciated that the criteria (e.g., triggering questions) included in steps 410, 415 and 420 may be utilized to assess the received issue in an order different from that shown in FIG. 4, and also may include other criteria and/or questions in addition to or instead of those shown.

In step 410 it is determined whether the issue received from the customer in step 400 involved the customer referring to the need to seek legal and/or media assistance with the issue. For example, the customer may make several inquiries to the receiving associate and then upon receiving an unsatisfactory response from the associate, indicate that he or she will have to seek legal counsel or alert the local media if certain action is not taken. If no such reference is found to have been made by the customer in step 410, then step 415 determines whether the customer requested to “go on record” with his or her issue. Although a request to “go on record” may include a variety of different actions, one example is a request that the receiving associate make a note or comment in the customer's account regarding the particular issue. If no request to “go on record” is found in step 415, then in step 420 it is determined whether the customer requested that the issue be escalated beyond the receiving associate's manager or direct supervisor. For example, a customer may request to speak with or submit his or her issue to an individual or department of the organization that is above the associate's manager in the chain of command of the organization.

If none of the criteria set out in steps 410, 415 and 420 are met, then the process ends with the issue received from the customer being determined to be something other than a complaint. As such, issues from customers that are found not to be complaints do not cause unnecessary delay and/or result in undue amounts of effort being exerted in handling and resolving such issues as complaints. However, if the issue received is determined to be a complaint in any of steps 410, 415 and 420, then the process continues to step 425 where information (e.g., data) associated with the identified complaint begins to be collected.

In steps 425, 430 and 435, information associated with the issue identified as a complaint is collected, for example, by the receiving associate entering such information into the system of record (e.g., one of systems of record 310a through 310n shown in FIG. 3) of the business unit in which the complaint was received. In step 425 the associate may enter customer identification information, in step 430, complaint information, and in step 435, information about the receiving associate (and any other secondary associates and/or individuals who may have been involved with receiving the issue before the issue was identified as a complaint). In some arrangements, any of the various items of complaint data 325 shown, for example, in FIG. 5, may be collected in the system of record in steps 425, 430 and 435 in addition to or instead of the items associated with such steps in FIG. 4.

In step 440, it is determined whether any updated information associated with the complaint (e.g., updated complaint data 325) has been received. For example, the receiving associate or another individual of the organization may determine that the issue identified as a complaint was already identified as such at some previous time, and therefore, the issue is actually additional or new information about the previously identified complaint. If it is found that new information about an existing complaint is received, then such information is used to update the complaint data being maintained in the system of record for the business unit. The process ultimately proceeds to step 450 where complaint data (e.g., complaint data 325) is extracted or uploaded from the system of record to the complaint portal. In some arrangements, step 450 may occur on a continual basis, in which data is extracted or made available for uploading to the complaint portal as soon as such data is collected and/or updated in steps 425 through 445. In other arrangements, data may be extracted or uploaded according to some schedule or periodic time interval set by the organization.

Although specific examples of carrying out the aspects of the disclosure have been described, those skilled in the art will appreciate that there are numerous variations and permutations of the above-described systems and methods that are contained within the spirit and scope of the disclosure as set forth in the appended claims. Additionally, numerous other embodiments, modifications and variations within the scope and spirit of the appended claims will occur to persons of ordinary skill in the art from a review of this disclosure.

We claim:

1. A method comprising:
maintaining, in a server of a business unit of an organization, data associated with one or more complaints received at the business unit from customers of the organization;
updating the data maintained in the server with new data associated with the one or more complaints received at the business unit;
extracting the updated data associated with the one or more complaints from the server to a complaint portal of the organization; and
reporting, by the complaint portal, the extracted data to one or more business units of the organization for resolution of the one or more complaints.

2. The method of claim 1, further comprising:
receiving, at the server, an issue communicated to the business unit from a customer of the organization;
identifying, by the server, the received issue as a complaint; and
receiving, at the server, data associated with the identified complaint.

3. The method of claim 2, wherein the server identifying the issue as a complaint includes:
determining the received issue was not resolved by an associate of the business unit; and
analyzing the issue using a set of criteria, wherein the set of criteria includes one or more rules defining a complaint.

4. The method of claim 2, wherein the data associated with the identified complaint includes data about one or more of: an identification of the customer, a complaint type of the identified complaint, an associate of the business unit associated with the received issue, and a status of the identified complaint.

5. The method of claim 1, wherein the reporting, by the complaint portal, the extracted data to one or more business units of the organization includes:
generating, by the complaint portal, one or more reports based on the extracted data; and
transmitting, by the complaint portal, the one or more reports to the one or more business units.

6. The method of claim 5, further comprising:
identifying, by the complaint portal, a business unit of the organization responsible for resolution of a complaint of the one or more complaints; and
transmitting, by the complaint portal, a notification to the business unit responsible for resolution of the complaint, the notification indicating an availability of the one or more reports generated by the complaint portal.

7. The method of claim 1, wherein the server is one of a plurality of servers, each of the plurality of servers being associated with a different business unit of the one or more business units of the organization, and further comprising:
transmitting, by the complaint portal, a request for complaint data to the plurality of servers; and
receiving, at the complaint portal, the requested complaint data from the plurality of servers.

8. A method comprising:
receiving, at a server, issues communicated to a business unit of an organization from customers of the organization;
identifying, by the server, one or more complaints based on the received issues;
receiving, at the server, data associated with the one or more complaints; and
uploading, by the server, the received data associated with the one or more complaints to a complaint portal of the organization.

9. The method of claim 8, further comprising:
storing, by the server, the received data associated with the one or more complaints;
receiving, at the server, new data associated with the one or more complaints; and
updating, by the server, the stored data associated with the one or more complaints with the new data associated with the one or more complaints.

10. The method of claim 8, wherein the server identifying the one or more complaints based on the received issues includes:
determining, by the server, a received issue was not resolved by the business unit; and
analyzing the issue using a set of criteria, wherein the set of criteria includes one or more rules defining a complaint.

11. The method of claim 8, wherein the data associated with the one or more complaints includes one or more of: an identification of one or more customers associated with the one or more complaints, a complaint type of the one or more complaints, an identification of one or more associates of the business unit associated with the received issues, and a status of the one or more complaints.

12. The method of claim 8, further comprising:
receiving, at the server, a request for complaint data from the complaint portal; and
responsive to receiving the request, the server transmitting the data associated with the one or more complaints to the complaint portal.

13. One or more computer-readable media storing computer-readable instructions that, when executed by at least one computer, cause the at least one computer to perform a method of:
identifying one or more complaints based on issues received at a business unit of an organization from customers of the organization;
receiving data associated with the one or more complaints;
storing the received data associated with the one or more complaints; and
uploading the received data associated with the one or more complaints to a central complaint portal of the organization.

14. The one or more computer-readable media of claim 13, the computer-readable instructions that, when executed by at least one computer, further cause the at least one computer to perform:
receiving new data associated with the one or more complaints; and
updating the stored data associated with the one or more complaints with the new data associated with the one or more complaints.

15. The one or more computer-readable media of claim 13, the computer-readable instructions that, when executed by at least one computer, further cause the at least one computer to perform:
determining a received issue was not resolved by the business unit; and
analyzing the issue using a set of criteria, wherein the set of criteria includes one or more rules defining a complaint.

16. The one or more computer-readable media of claim 13, the computer-readable instructions that, when executed by at least one computer, further cause the at least one computer to perform:
receiving a request for complaint data from the central complaint portal; and
responsive to receiving the request, transmitting the data associated with the one or more complaints to the central complaint portal.

17. One or more computer-readable media storing computer-readable instructions that, when executed by at least one computer, cause the at least one computer to perform a method of:
transmitting a request for complaint data to a plurality of servers associated with business units of an organization;
receiving the requested complaint data from the plurality of servers;
generating one or more reports based on the received complaint data; and
transmitting the one or more reports to the business units of the organization.

18. The one or more computer-readable media of claim 17, the computer-readable instructions that, when executed by at least one computer, further cause the at least one computer to perform:
identifying a business unit of the organization responsible for resolving one or more complaints associated with the complaint data; and
transmitting a notification to the business unit, the notification indicating an availability of the one or more reports.

19. The one or more computer-readable media of claim 17, the computer-readable instructions that, when executed by at least one computer, further cause the at least one computer to perform:
determining new complaint data is received by one of the plurality of servers; and
automatically extracting the new complaint data from the one of the plurality of servers.

20. An apparatus comprising:
a processor; and
a memory storing computer-readable instructions that, when executed by the processor, cause the processor to perform:
transmitting a request for complaint data to a plurality of servers associated with business units of an organization;
receiving the requested complaint data from the plurality of servers;
generating one or more reports based on the received complaint data;
identifying a business unit of the organization responsible for one or more complaints associated with the complaint data; and
transmitting the one or more reports to the business unit of the organization.
